(19) United States
(12) Patent Application Publication
(10) Pub. No.: US 2015/0048095 A1
(43) Pub. Date: Feb. 19, 2015

(54) COMPRESSED GAS STORAGE SYSTEMS

(71) Applicant: HECR, LLC, Fort Wayne, IN (US)

(72) Inventor: Stan A. Sanders, Fort Wayne, IN (US)

(21) Appl. No.: 14/532,116

(22) Filed: Nov. 4, 2014

Related U.S. Application Data
(63) Continuation-in-part of application No. 14/081,779, filed on Nov. 15, 2013.
(60) Provisional application No. 61/908,350, filed on Nov. 25, 2013.
(60) Provisional application No. 61/917,598, filed on Dec. 18, 2013.
(60) Provisional application No. 61/733,282, filed on Dec. 4, 2012.

(51) Int. Cl. F17C 1/08; B65B 5/04; B21D 15/06

(52) U.S. Cl. CPC F17C 1/08; B21D 15/06; B65B 5/04; F17C 2201/0104; F17C 2203/012; F17C 2209/21
USPC 220/586; 53/473

(57) ABSTRACT

A pressure vessel is disclosed. The pressure vessel includes a continuous liner of corrugated material including a plurality of alternating main sections and intermediate sections. The main sections have a first diameter and the intermediate sections have a second diameter smaller than the first diameter. The pressure vessel also includes at least one reinforcing layer applied to an exterior of the continuous liner. The pressure vessel can be packaged in containers for modular use, with one or more containers being shaped to receive a portion of the reinforced continuous liner folded along one or more of the intermediate sections.

### CROSS-REFERENCE TO RELATED APPLICATIONS

This application claims the benefit of: U.S. Provisional Patent Application Ser. No. 61/908,350, titled “Oxygen Belt Breathing Pack,” filed Nov. 25, 2013; and U.S. Provisional Application Ser. No. 61/917,598, titled “Compressed Natural Gas Fuel Cell,” filed Dec. 18, 2013. This application is a continuation in part of U.S. Utility Patent Application Ser. No. 14/081,779, titled “Integrated Dive Suit,” filed Dec. 4, 2013, which claims the benefit of U.S. Provisional Patent Application Ser. Number 61/733,282, titled “Integrated Dive Suit,” filed Dec. 4, 2012. The contents of the '350, '598, '779, and '282 applications are incorporated herein by reference.

### FIELD

This disclosure relates generally to the field of compressed gas storage systems, and more specifically, to light weight, explosion-proof systems for use on trucks, automobiles, and other vehicles, for use in wearable breathing systems, and for use in dive suits with integrated breathing and buoyancy control systems.

### BACKGROUND

In terms of vehicular fuel systems, many vehicles, such as large trucks, buses, and heavy equipment, employ diesel engines and related fuel systems. While such systems are relatively efficient, they produce hydrocarbons and other pollutants that are difficult to control. There is presently a substantial movement to replace these systems with compressed gas storage systems, including compressed gas storage systems that use compressed natural gas (CNG) as recent discoveries of natural gas have been significant.

Compressed gas fuels produce substantially less pollution when used in internal combustion engines than diesel fuel. In addition, the refining costs are substantially lower than diesel fuel, resulting in lower cost for equivalent motive power. Using compressed gas as a fuel for vehicles requires that the gas be easily transportable and that the compressed gas storage system can be rapidly and safely refilled.

Compressed gas can be stored in pressure vessels. The present technology for CNG or other compressed gas storage involves heavy metal or hoop-wound carbon fiber tanks. These tanks are typically of a cylindrical shape for maximum strength. Such tanks can be extremely heavy, difficult to mount on a vehicle, and are subject to explosion upon impact. The present disclosure addresses these problems with a light weight system capable of being formed into a variety of useful shapes that is easily filled, low cost, and explosion proof.

In terms of wearable breathing systems, patients that require supplementary oxygen on a routine basis are amongst those least able to cope with the weight and bulk of present day portable oxygen systems. Typically, these portable oxygen systems consist of a heavy metallic reservoir mounted to a wheeled trolley or back pack. The portable oxygen systems also include a fill valve, pressure regulator, delivery hose, and cannula for provision of oxygen to the patient's nose. These portable oxygen systems typically weigh 6-9 pounds, operate at approximately 2000 psi, and can provide up to three hours breathing time at a typical delivery rate. The weight and bulk of these portable oxygen systems make them awkward to transport and use. In addition, a certain stigma attaches to the use of these bulky portable oxygen systems and tends to discourage those who need them from being out in public.

The present disclosure describes a lightweight, compact oxygen supply and associated breathing apparatus for the ambulatory care patient that allows the apparatus to be as unobtrusive as possible. The breathing apparatus can use compressed gas stored in pressure vessels that will not explode when exposed to heat, cold, or crushing force and that will dissipate pressure in a controlled manner. The breathing apparatus can be worn comfortably for long periods of time and can be rapidly filled, is durable, and is inexpensive to produce.

In terms of in dive suits with integrated breathing and buoyancy control systems, the first commercially successful scuba equipment was the Aqualung twin hose open circuit design developed by Emile Gagnan and Jacques-Yves Cousteau in 1942. Present day scuba equipment is similar to this original design except that virtually all modern scuba equipment uses a first stage pressure regulator positioned at the top end of a back mounted diving cylinder with a small second stage regulator held in the teeth of the diver. Both the original Aqualung equipment and modern day scuba gear employ large, relatively heavy metal or composite diving cylinders that the diver carries on his back, usually in conjunction with a buoyancy control apparatus.

These diving cylinders or diving tanks are heavy, usually at least 25-30 lbs., bulky, and uncomfortable to wear out of the water. The standard diving cylinder is known in the trade as an “aluminum 80,” as it contains 80 cubic feet of air at approximately 3000 psi. Women, being of smaller stature, find these tanks especially difficult to handle. Diving cylinders of this type are particularly problematic for certain specialized types of diving such as cave diving or wreck diving in which the diver must often maneuver through tight openings. This type of bulky diving cylinder can easily become caught in tight openings and represents a threat to the safety of the diver. In addition, the concentration of weight in the diving cylinder makes it especially difficult to maneuver when the diver is not in the water.

The present disclosure describes a lightweight, compact dive suit for scuba that integrates a breathing system with an integrated buoyancy control unit. The breathing system is configured to use a compressed gas pressure vessel that will not explode when exposed to heat, cold, or crushing force and that will dissipate pressure in a controlled manner. The pressure vessel can be configured for packaging with a vessel manifold that conforms to the diver's back for maximum comfort and the system can be rapidly filled, is durable, and is inexpensive to produce.

### SUMMARY

In one embodiment, a pressure vessel is disclosed. The pressure vessel includes a continuous liner of corrugated material including a plurality of alternating main sections and intermediate sections. The main sections of the continuous liner have a first diameter and the intermediate sections have a second diameter smaller than the first diameter. The pressure vessel further includes a reinforcing layer applied to an exterior of the continuous liner.

In another embodiment, a method of forming a pressure vessel is disclosed. The method includes forming a continuous liner and corrugating the continuous liner. The corrugation process includes forming a plurality of alternating main sections and intermediate sections. The main sections of the continuous liner have a first diameter and the intermediate sections have a second diameter smaller than the first diameter. The method further includes applying a reinforcing layer to an exterior of the continuous liner, folding the continuous liner along one or more of the intermediate sections, and packaging the folded continuous liner within at least one shaped container.

In another embodiment, a modular pressure vessel is disclosed. The modular pressure vessel includes a continuous liner including a plurality of alternating main sections and corrugated intermediate sections. The main sections have a first diameter and the corrugated intermediate sections have a second diameter smaller than the first diameter. The modular pressure vessel further includes a reinforcing layer applied to an exterior of the continuous liner and a plurality of containers each shaped to receive a portion of the reinforced continuous liner folded along one or more of the corrugated intermediate sections.

### BRIEF DESCRIPTION OF THE DRAWINGS

FIG. 1 is a partial side view of a corrugated, tubular, flexible pressure vessel;

FIG. 2 is a partial side view of a corrugated, tubular, flexible pressure vessel having a corrugated intermediate section of reduced diameter for increased flexibility;

FIG. 3 is a partial side view of a cylindrical pressure vessel illustrating a corrugated, reduced diameter intermediate section in a bent position;

FIG. 4 is a partial side view of a braided exterior treatment for use with any of the pressure vessels of FIGS. 1-3;

FIG. 5 is a partial side cut-away view of the braided exterior treatment being applied to the pressure vessel of FIG. 4;

FIG. 6 is a front cut-away view of the braided exterior treatment overlapping the continuous liner of FIG. 4;

FIG. 7 shows an example over-braid of carbon fiber or glass fiber for use on any of the pressure vessels of FIGS. 1-3;

FIG. 8 shows an example braiding process where two over-braid fibers are applied simultaneously from a single spool to the pressure vessel of FIG. 2;

FIG. 9 shows another example over-braid of both a carbon fiber tube or sock positioned over the over-braid fibers of FIG. 8 as well as a second braided layer applied over the carbon fiber tube or sock;

FIG. 10 shows another example carbon fiber tube or sock cut to the length of the main section of the pressure vessel of FIG. 1;

FIG. 11 shows another example over-braid formed of resin-impregnated tape applied to opposite sides of any of the pressure vessels of FIGS. 1-3 at the same time in a bi-weave pattern;

FIG. 12 is a side view of the bi-weave pattern over-braid of FIG. 11 including a view of two spools of resin-impregnated tape;

FIG. 13 is a top view of an example process for manufacturing a pressure vessel;

FIG. 14 is a side view of the example process of FIG. 13;

FIG. 15 is a top view of an example sub-process for manufacturing a continuous pressure vessel within the process of FIGS. 13 and 14;

FIG. 16 is a side cut-away view of an example drying device for manufacturing a pressure vessel;

FIG. 17 is a side view of a continuous, tubular pressure vessel folded along a plurality of intermediate sections;

FIG. 18 is a side view of a plurality of linked pressure vessels;

FIG. 19 is a perspective view of a series of linked pressure vessels in a shaped container;

FIG. 20 is a perspective view of a continuous pressure vessel folded for packaging within a modular container along a plurality of reduced diameter intermediate sections;

FIG. 21 is a perspective view of a fully assembled compressed gas modular storage system including a plurality of the modular containers shown in FIG. 20;

FIG. 22 is a schematic illustration of a fuel storage and delivery system for use in a vehicle incorporating at least one modular container similar to those described in FIGS. 19-21;

FIG. 23 is a perspective view of shaped containers containing continuous, flexible pressure vessels attached to the sides and behind the cab of a truck;

FIG. 24 is a perspective view of shaped containers containing continuous, flexible pressure vessels formed to fit within the trunk lid, roof, hood, and fenders of a vehicle;

FIG. 25 is a perspective view of shaped containers containing continuous, flexible pressure vessels formed to fit within and around a chassis of the truck of FIG. 23;

FIG. 26 is a perspective view of a continuous, flexible pressure vessel formed to fit on a roof of a bus;

FIG. 27 is a side view of a continuous pressure vessel within an outline representing an oxygen belt breathing pack;

FIG. 28 is a side view of the oxygen belt breathing pack of FIG. 27 including a nasal cannula and a manifold;

FIG. 29 is a rear view of the oxygen belt breathing pack of FIG. 28 as worn by an ambulatory care patient;

FIG. 30 is an exploded rear view of a dive suit illustrating the assembly of the continuous pressure vessel and a hydrodynamic container; and

FIG. 31 is a side cut-away view of a portable container including a continuous, flexible pressure vessel similar to those described in FIGS. 1-8.

### DETAILED DESCRIPTION

A pressure vessel, methods for forming the pressure vessel, and modular containers for packaging the pressure vessel are disclosed. The pressure vessel can include a continuous liner with either smooth or corrugated main sections and reduced diameter corrugated intermediate sections formed to hold a compressed gas, such a natural gas or oxygen. The pressure vessel can also include one or more reinforcing layers applied to an exterior of the continuous liner and can be bent, folded, or rolled using the corrugated and flexible intermediate sections for packaging within a variety of containers, such as containers for use in vehicle applications, in healthcare applications, and in scuba diving.

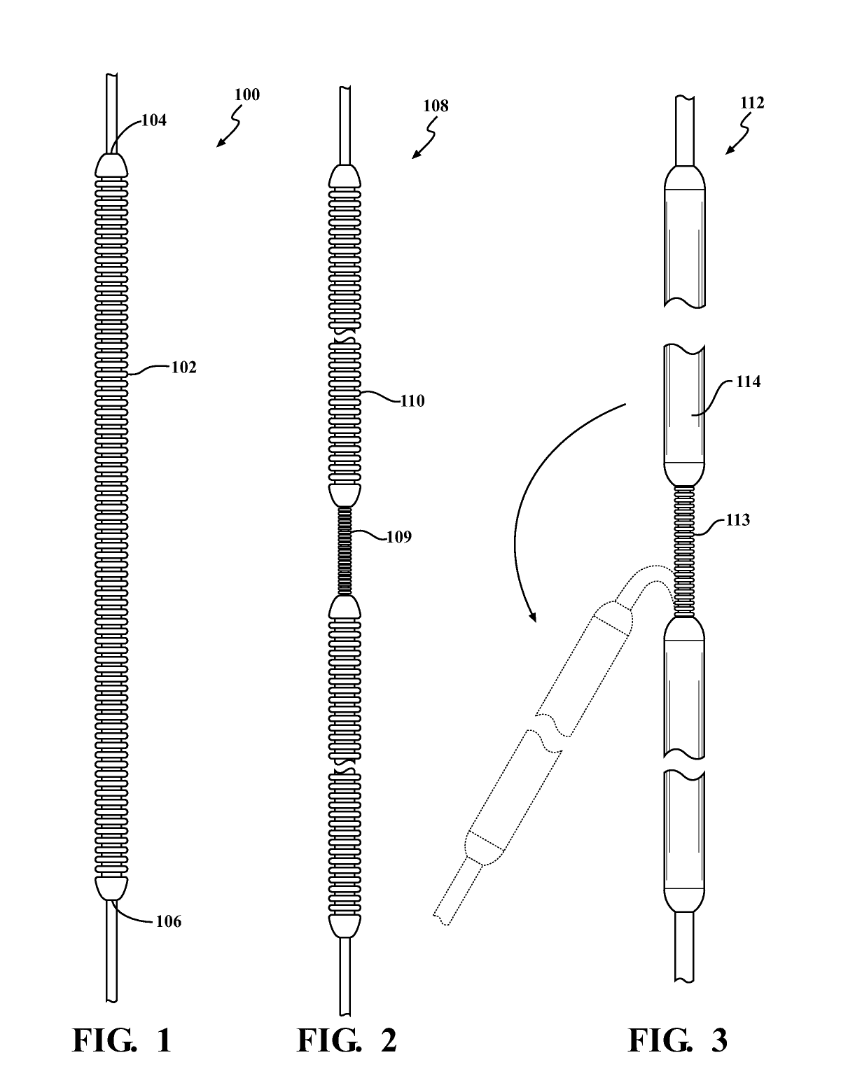

FIG. 1 is a partial side view of a corrugated, tubular, flexible pressure vessel 100. The pressure vessel 100 is formed from a cylindrical, elongated, corrugated, continuous liner 102 having a corrugated main section and reduced diameter ends 104, 106. In alternative embodiments, the pressure vessel 100 can include any of an elongated cylindrical shape, an ovoid shape, and a spherical shape. The continuous liner 102 can also be called a continuous core or a continuous tube, the terms continuous liner, continuous core, and continuous tube all intended to indicate the seamless inner layer of the pressure vessel 100 configured to hold the compressed gas.

FIG. 2 is a partial side view of another corrugated, tubular, flexible pressure vessel 108 having both a pair of corrugated main sections and a corrugated intermediate section 109 of reduced diameter along a continuous liner 110 for increased flexibility. The corrugated intermediate section 109 has a reduced diameter to provide increased flexibility when forming the pressure vessel 108 into a compact shape to fit, for example, into a container. Further, both the main sections and the intermediate section 109 of the continuous liner 110 are corrugated to provide maximum flexibility and strength. By corrugating the intermediate section 109, the pressure vessel 108 can more easily bend without kinking. The ease of bending the pressure vessel 108 is its basis for conformability to various containers.

FIG. 3 is a partial side view of a cylindrical pressure vessel 112 illustrating a pair of smooth main sections and a corrugated, reduced diameter intermediate section 113 in a bent position along a continuous liner 114. The bent position is shown in dotted lines with an arrow indicating how the pressure vessel 112 can be bent at the corrugated, reduced diameter intermediate section 113 without kinking.

The pressure vessels 108, 112 of FIGS. 2 and 3 include single reduced diameter corrugated intermediate sections 109, 113 between two main sections, though additional reduced diameter corrugated intermediate sections between additional main sections are also possible. The main sections in the examples of FIGS. 2 and 3 are smooth and corrugated, respectively, and both have a diameter measuring approximately three times the diameter of the corrugated intermediate sections 109, 113, though other diameter ratios between the smooth or corrugated main sections and the corrugated intermediate sections 109, 113 are also possible.

The continuous liners 102, 110, 114 of FIGS. 1-3 can, for example, be formed by an extrusion process, a hydroform process, or a metal spinning process prior to being corrugated either along both the main sections and intermediate sections 109, 113 or just along the intermediate sections 109, 113. The smooth and/or corrugated material forming the pressure vessels 100, 108, 112 can, for example, be polymeric, aluminum, copper, or stainless steel.

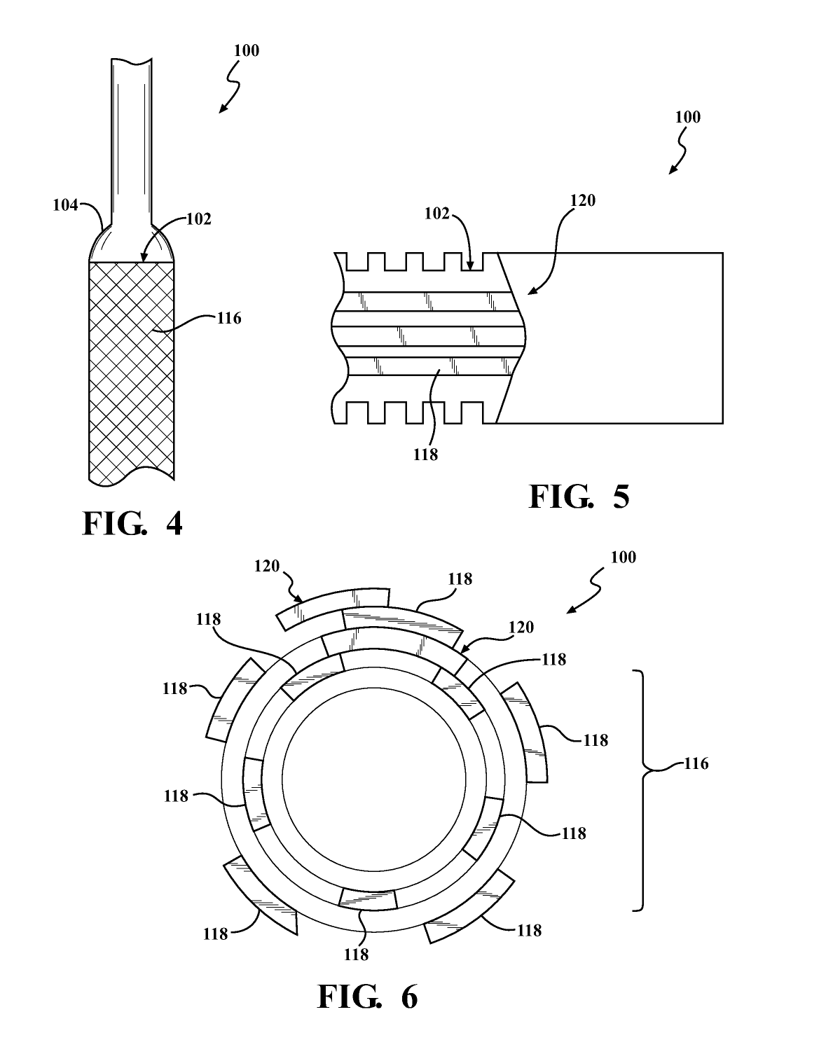

FIG. 4 is a partial side view of a braided exterior treatment 116, an example of a reinforcing layer, for use with any of the pressure vessels 100, 108, 112 of FIGS. 1-3. In this example, the braided exterior treatment 116 is applied to the exterior of the main section of the continuous liner 102 but not to the reduced diameter end 104 of the pressure vessel 100 of FIG. 1. The braiding process for the braided exterior treatment 116 can include encasing the pressure vessel 100,108,112 in high strength fiber material, such as rayon, nylon, glass, or Kevlar® (aramid), or a combination thereof.

FIG. 5 is a partial side cut-away view of the braided exterior treatment 116 being applied to the pressure vessel 100 of FIG. 4. The continuous, corrugated liner 102 is covered with axial fibers 118 that run along the longitudinal axis of the pressure vessel 100 to prevent the pressure vessel 100 from growing in length. The axial fibers 118 are applied in an overlapping fashion by both rotating and translating the continuous, corrugated liner 102 forward and backward using a magnetic shuttle drive 120 during the braiding process to create the braided exterior treatment 116 as shown in FIG. 4.

FIG. 6 is a front cut away view of the braided exterior treatment 116 overlapping the continuous, corrugated liner 102 of FIG. 4. FIG. 6 shows the geometry and spacing of the axial fibers 118 as applied by the magnetic shuttle drive 120 to the continuous, corrugated liner 102. This braiding geometry allows flexibility of the pressure vessel 100 while providing reinforcing strength to the pressure vessel 100 in the form of the braided exterior treatment 116.

In addition to braiding the pressure vessel 100 in high strength fibers, such as axial fibers 118, the pressure vessel 100 can be over-braided, that is, one or more additional reinforcing layers can be added to the outside of the first reinforcing layer on the pressure vessel 100 to allow for even better high pressure retention properties.

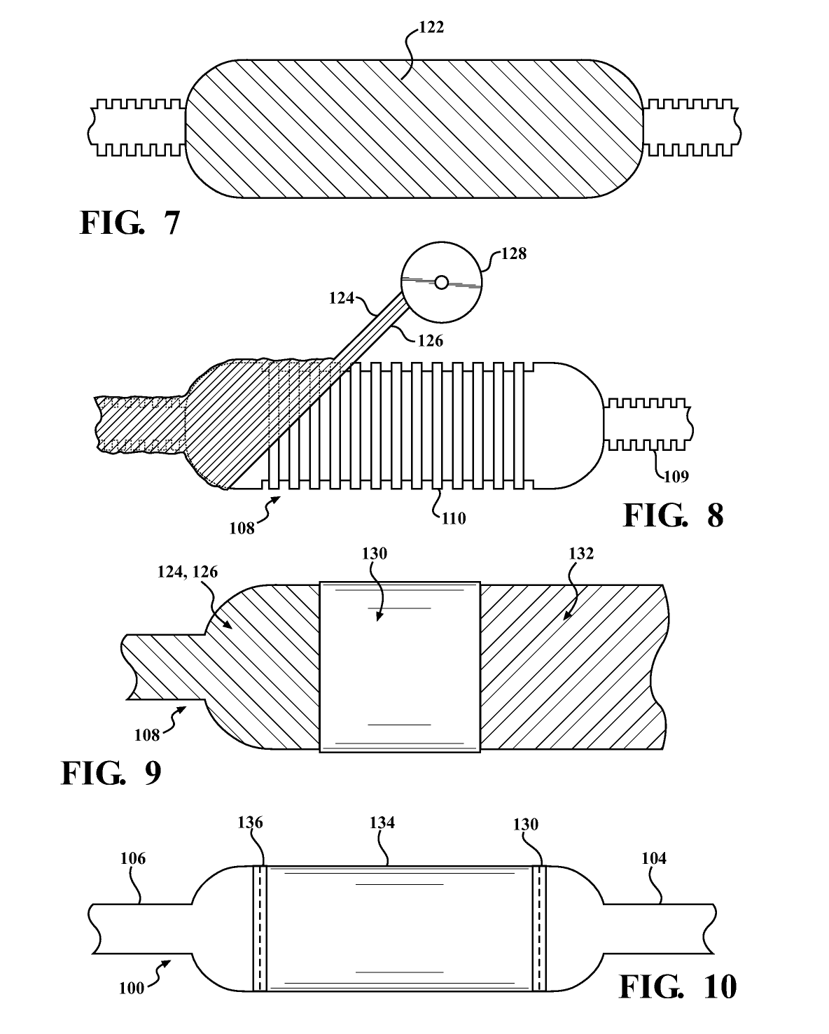

FIG. 7 shows an example over-braid 122 of carbon fiber or glass fiber for use on any of the pressure vessels 100, 108, 112 of FIGS. 1-3. The over-braid in FIG. 7 ends before the reduced diameter corrugated intermediate sections in order to allow these sections to remain flexible.

FIG. 8 shows an example braiding process where two over-braid fibers 124, 126 are applied simultaneously from a single spool 128 to the pressure vessel 108 of FIG. 2. This simultaneous application allows for a faster production rate. In this example, the two over-braid fibers 124, 126 are applied over both the corrugated main section of the continuous liner 110 and the corrugated intermediate section 109.

FIG. 9 shows another example over-braid of both a carbon fiber tube or sock 130 positioned over the over-braid fibers 124, 126 of FIG. 8 as well as a second braided layer 132 applied over the carbon fiber tube or sock 130. In this example, the first layer of over-braid fibers 124, 126 can be formed of Kevlar™ with carbon ribbing and the second braided layer 132 (that is, the layer placed over the carbon fiber tube or sock 130) can be formed of a 903 Kevlar™. Alternatively, the carbon fiber tube or sock 130 can be applied as the only layer of over-braid. The carbon fiber tube or sock 130 can be applied using, for example, an epoxy resin pre-impregnated on the carbon fiber tube or sock 130 or can be adhered by injecting the resin under vacuum after the carbon fiber tube or sock 130 is placed over the pressure vessel 108. Once the carbon fiber tube or sock 130 and resin are applied, the pressure vessel 108 can be cured under ultraviolet light.

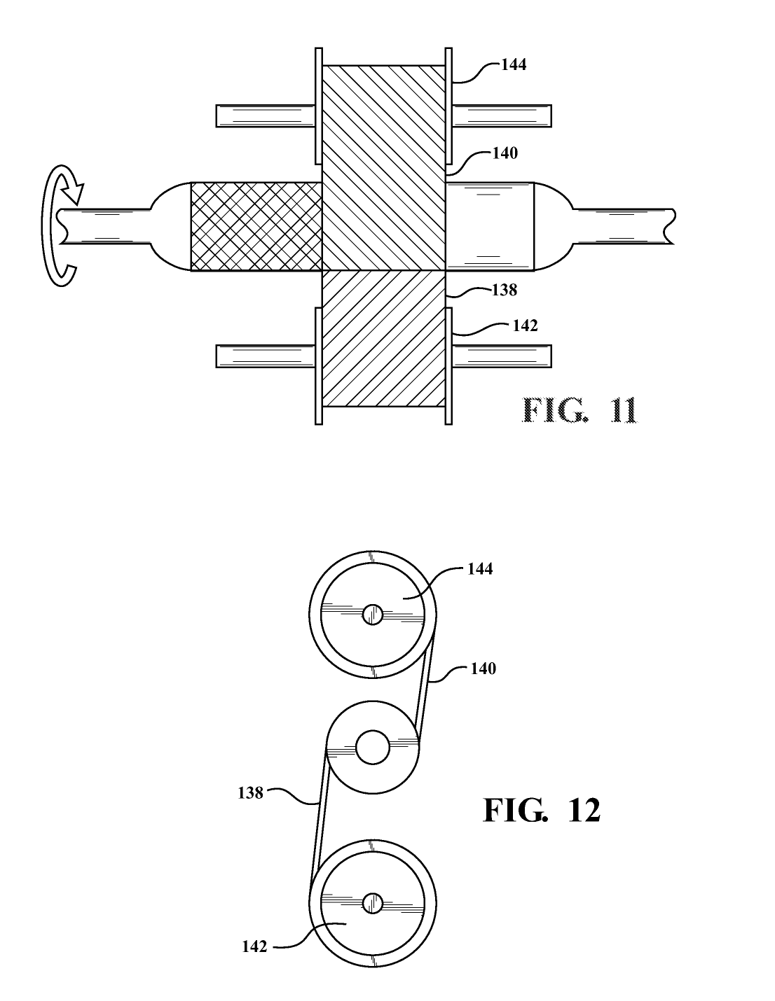

FIG. 10 shows another example carbon fiber tube or sock 134 cut to the length of the main section of the pressure vessel 100 of FIG. 1. The carbon fiber tube or sock 134 can include stitching 136 at its ends to prevent unraveling during the application process.

FIG. 11 shows another example over-braid formed of resin-impregnated tape 138, 140 applied to opposite sides of any of the pressure vessels 100, 108, 112 of FIGS. 1-3 at the same time in a bi-weave pattern. For example, the bi-weave pattern is formed in a different direction on each of the spools 142, 144 of resin-impregnated tape 138, 140, such that when both resin-impregnated tapes 138, 140 are applied and cured, a cross pattern is form imparting additional strength to the over-braid.

FIG. 12 is a side view of the bi-weave pattern over-braid of FIG. 11 including a view of the two spools 142, 144 of resin-impregnated tape 138, 140. In another embodiment (not shown), any of the pressure vessels in the previous examples can be wrapped with a high strength ballistic ribbon material. The high strength ballistic ribbon material can be selected from the group consisting of prepreg carbon fiber or prepreg glass fiber.

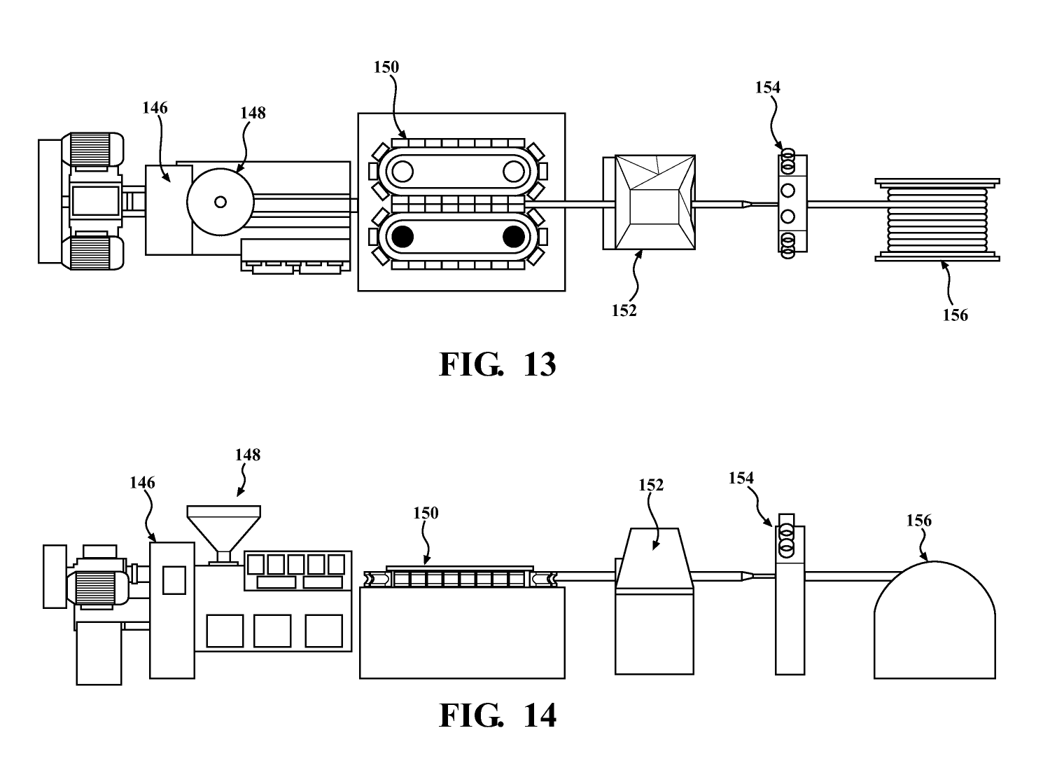

FIG. 13 is a top view of an example process for manufacturing a pressure vessel, such as any of the pressure vessels 100, 108, 112 of FIGS. 1-8. FIG. 14 is a side view of the example process of FIG. 13. This example process includes the steps of extrusion of a polymer, corrugation, thickness monitoring, braiding, and spooling the completed pressure vessel.

At the beginning of the process, an extruder 146 can heat the raw polymer, for example, as supplied by a hopper 148 to form a molten polymer. The molten polymer can be forced through an extrusion head of the extruder 146 to create a continuous and seamless core, e.g. a hollow tube or liner for the pressure vessel. The temperature and pressure required to produce the molten polymer and extrude the seamless core are specific to the particular type of polymer used and its intended application. The seamless core can then be continuously pushed through a corrugation device 150.

The corrugation device 150 or corrugation table can include set of paired mold blocks attached to counter-rotating drive trains. The seamless core can be pushed into the space between rotating mold blocks while the internal pressure of the seamless core is increased. The molten polymer can be forced against the mold blocks such that the mold blocks shape the walls of the seamless core into the corrugated shape. The corrugated, seamless core can cool sufficiently upon exit of the corrugation device 150 to maintain the corrugated shape.

After exiting the corrugation device 150, the corrugated, seamless core can be passed through a thickness monitor 152 to measure the wall thickness using, for example, ultrasound waves as a quality check. This thickness monitor 152 can be a separate device or part of the corrugation device 150.

After exiting the thickness monitor 152, the corrugated, seamless core can enter a braiding device 154, where, for example, a high strength fiber material, such as rayon, nylon, glass or Kevlar™, or a combination thereof, is applied to the corrugated, seamless core. This first example reinforcing layer, the braided layer, as applied over the corrugated, seamless core adds strength to the pressure vessel. In the example shown in FIGS. 13 and 14, the braiding device 154 supplies the fiber material from bobbins.

After exiting the braiding device 154, a spooling machine 156 can collect the pressure vessel in a single continuous length. The pressure vessel can then be unspooled and cut to a desired length for use in specific applications.

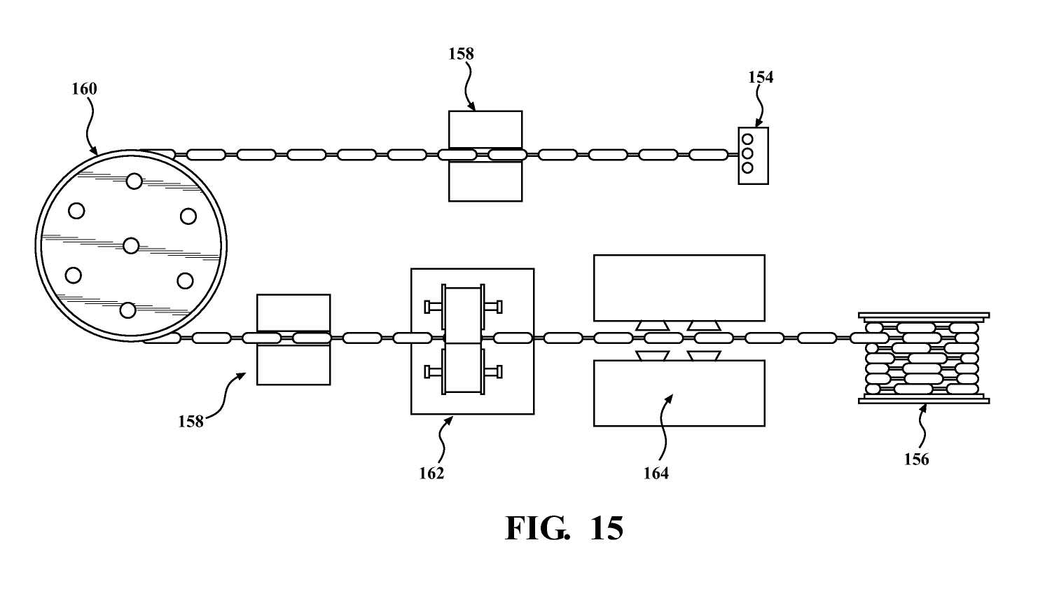

FIG. 15 is a top view of an example sub-process for manufacturing a continuous pressure vessel within the process of FIGS. 13 and 14. This example sub-process includes the steps of applying an over-braid material and curing the over-braid material. These steps can occur after the extrusion, corrugation, and preliminary braiding process but before the spooling process described in reference to FIGS. 13 and 14.

After exiting the braiding device 154 of FIGS. 13 and 14, torque can be applied to the continuous pressure vessel by a rotation device 158 to spin the continuous pressure vessel and the direction of the manufacturing line can be altered by an optional return pulley device 160. If the return pulley device 160 is used, another rotation device 158 can be used to keep the pressure vessel both moving and spinning through the manufacturing sub-process. The use of a return pulley device 160 allows the manufacturing sub-process to take up less space within a facility.

After traveling through the rotation devices 158 and optional return pulley 160, the continuous pressure vessel can enter an over-braid applicator 162, and in this example, a resign-impregnated bi-weave material is applied to the rotating continuous pressure vessel as described in references to FIGS. 11 and 12 above. Alternatively, the over-braid applicator 162 can be configured to apply carbon fibers or carbon fiber tubes or socks such as those shown in FIGS. 7-10. The over-braid applicator 162 can also be configured to apply high strength ballistic ribbon material. Bi-weave material, carbon fiber tubes or socks, and ballistic ribbons are just examples of the various over-braid processes that can be applied by the over-braid applicator 162 to further strengthen the continuous pressure vessel.

After the over-braid is applied, the continuous pressure vessel can enter a drying device 164, and in this example, the drying device 164 can apply ultraviolet light to dry the resin within the bi-weave material, fixing the position of the over-braid to surround the first reinforced layer of braided material below it. After exiting the drying device 164, the continuous pressure vessel can be rolled by the spooling machine 156 as previously described.

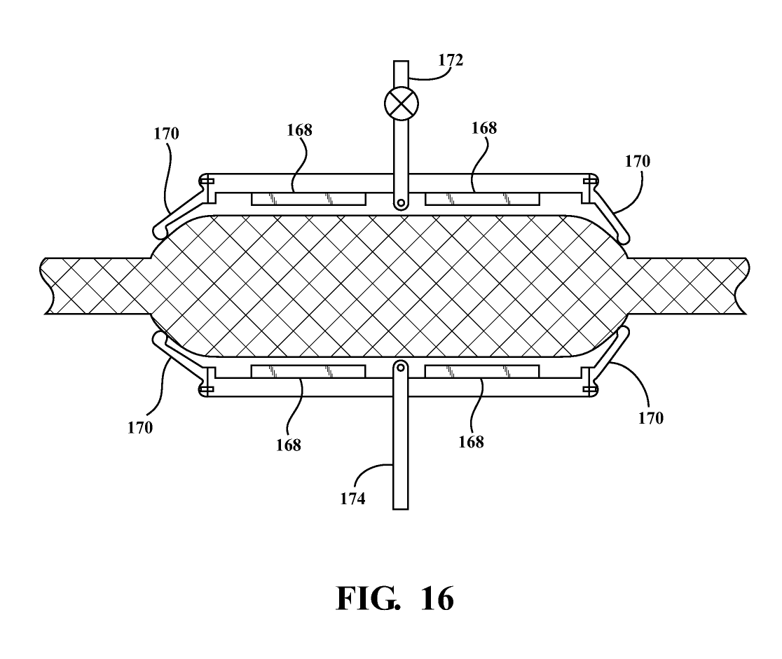

FIG. 16 is a side cut-away view of an example drying device 166 for manufacturing a continuous pressure vessel, such as the pressure vessels 100, 108, 112 of FIGS. 1-11. The drying device 166 can receive the continuous pressure vessel after a braiding and/or over-braiding process are complete. The drying device 166 includes a plurality of either laser or ultraviolet light sources 168 on the inside of a ring-shaped chamber sealed by a plurality of flexible end seals 170 fitted to the tapering portions of the continuous pressure vessel near the corrugated intermediate sections. The drying device 166 also includes both a pressurized air source 172 and a heated air source 174 configured to surround the continuous pressure vessel in pressurized and heated air at the same time that the laser or ultraviolet light sources 168 direct light at the continuous pressure vessel. The combination of three different drying processes within the sealed chamber of the drying device 166 limits the amount of time needed to dry and/or cure any of the braided or over-braided materials applied to the corrugated, seamless core, tube, or liner to form the continuous pressure vessel.

In addition to applying reinforcing layers to the exterior of the seamless core during the manufacturing process, the interior of the seamless core can be filled, for example, with adsorbent materials, such as nano-carbon or polymeric pellets, disposed within a sponge-like scaffold. The sponge-like scaffold can hold the adsorbent materials in place within the pressure vessel during fill and removal processes and can be configured to keep the pressure vessel from collapsing during removal of compressed gas. Use of adsorbent materials within the seamless core can allow the compressed gas to be stored at a lower pressure.

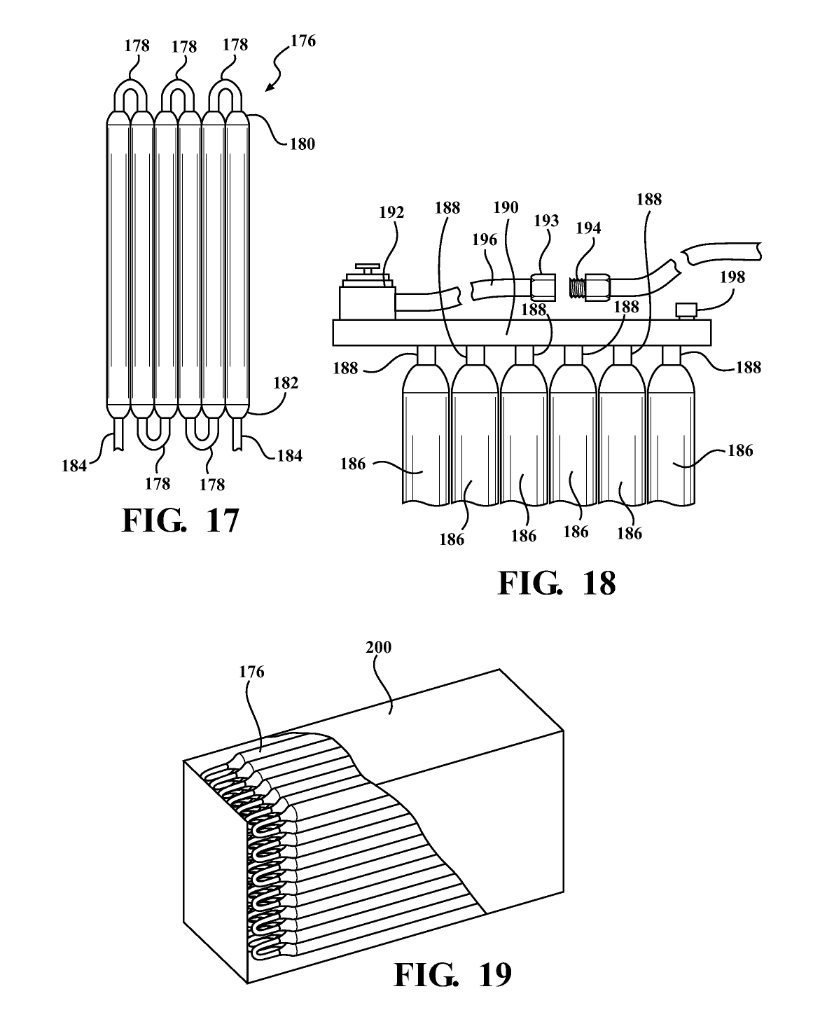

FIG. 17 is a side view of a continuous, tubular pressure vessel 176 folded along a plurality of intermediate sections 178. The intermediate sections 178 are of a reduced diameter, with each intermediate section 178 disposed between a main section of a larger diameter. The intermediate sections 178 and the main sections can be both corrugated and covered by one or more reinforcing layers, such as the reinforcing layers shown in FIGS. 4-12. The pressure vessel 176 has a first end 180 and a second end 182. The second end 182 has at least one attached section of flexible conduit 184. The flexible conduit 184 can be attached, for example, to a manifold as described below.

FIG. 18 is a side view of a plurality of linked pressure vessels 186. The link is formed using flexible conduit 188, a manifold 190, a high pressure regulator 192, a fuel fill fitting 193, and a fuel fill source 194. The manifold 190 is connected to the sections of flexible conduit 188 which are in turn each connected at least one pressure vessel 186. The manifold 190 provides connections for the high pressure regulator 192 and the fuel fill source 194. The high pressure regulator 192 can alternatively be an integral portion of the manifold 190. A low pressure hose 196 is connected to the high pressure regulator 192 and the fuel fill fitting 193 is connected to the low pressure hose 196. The manifold 190 can further include an overpressure rupture fitting 198. Though each pressure vessel 186 in this example is individually connected to the manifold 190, the pressure vessels 186 could alternatively be formed in single, continuous chain, with only two ends connected to the manifold 190. This alternative attachment could be implemented using the flexible conduits 184 and the pressure vessel 176 of FIG. 17.

FIG. 19 is a perspective view of a series of linked cylindrical pressure vessels, such as a series of folded pressure vessels similar to the pressure vessel 176 of FIG. 17, in a shaped container 200. The container 200 is formed of resilient material and is sized and shaped to accommodate a plurality of continuous pressure vessels, and if necessary, sections of flexible conduit to attach a manifold at one or more of the ends of the series of folded pressure vessels. The pressure vessels in FIG. 19 can include a reinforcing layer over smooth or corrugated main sections and corrugated intermediate sections. The reinforcing layer in this and previous examples can create a smooth exterior for the entire pressure vessel.

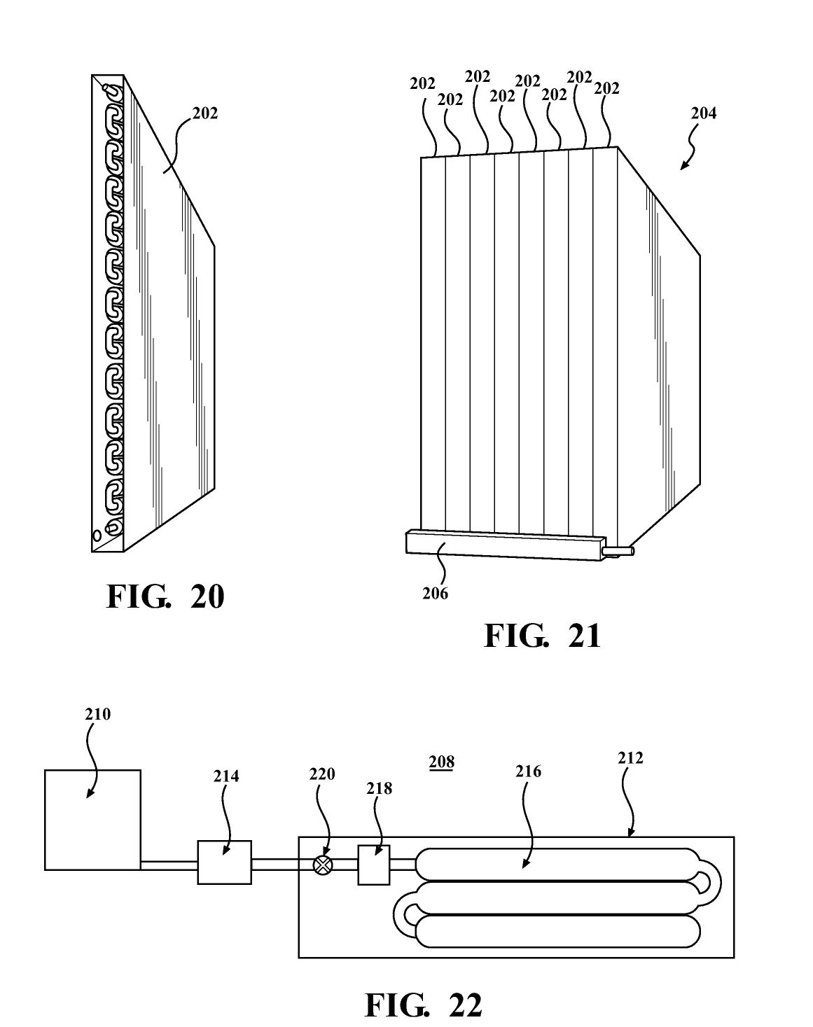

FIG. 20 is a perspective view of a continuous pressure vessel, such as the continuous pressure vessel 176 of FIG. 17, folded for packaging within a modular container along a plurality of reduced diameter intermediate sections. This singular modular container 202 is configured for packaging within groups of similar modular containers in order to facilitate easy replacement of portions of a compressed gas supply without replacement of the entire system.

FIG. 21 is a perspective view of a fully assembled compressed gas modular storage system 204 including a plurality of the modular containers 202 shown in FIG. 20. The compressed gas modular storage system 204 includes a manifold 206 for interconnecting each of the modular containers 202. The manifold 206 allows the group of modular containers 202 to act as a single compressed gas volume.

FIG. 22 is a schematic illustration of a fuel storage and delivery system 208 for use in a vehicle incorporating at least one modular container 212 similar to those described in FIGS. 19-21. Both an engine 210 and the at least one modular container 212 can supply fuel to a fuel regulator 214. In the case of the engine 210, the fuel can be gasoline or diesel. In the case of the modular container 212, the fuel can be compressed gas stored within a continuous pressure vessel 216. The modular container 212 can either include or be in fluid communication with both a pressure relief device 218 and a manual shut-off valve 220. The manual shut-off valve 220 and the pressure relief device 218 allow the modular container 212 to be safely removed from the fuel storage and delivery system 208 in order to service or refill the continuous pressure vessel 216. Though only a singular modular container 212 is shown in this example, multiple modular containers can be present within a vehicle and in fluid communication with the fuel regulator 214 as is further described below.

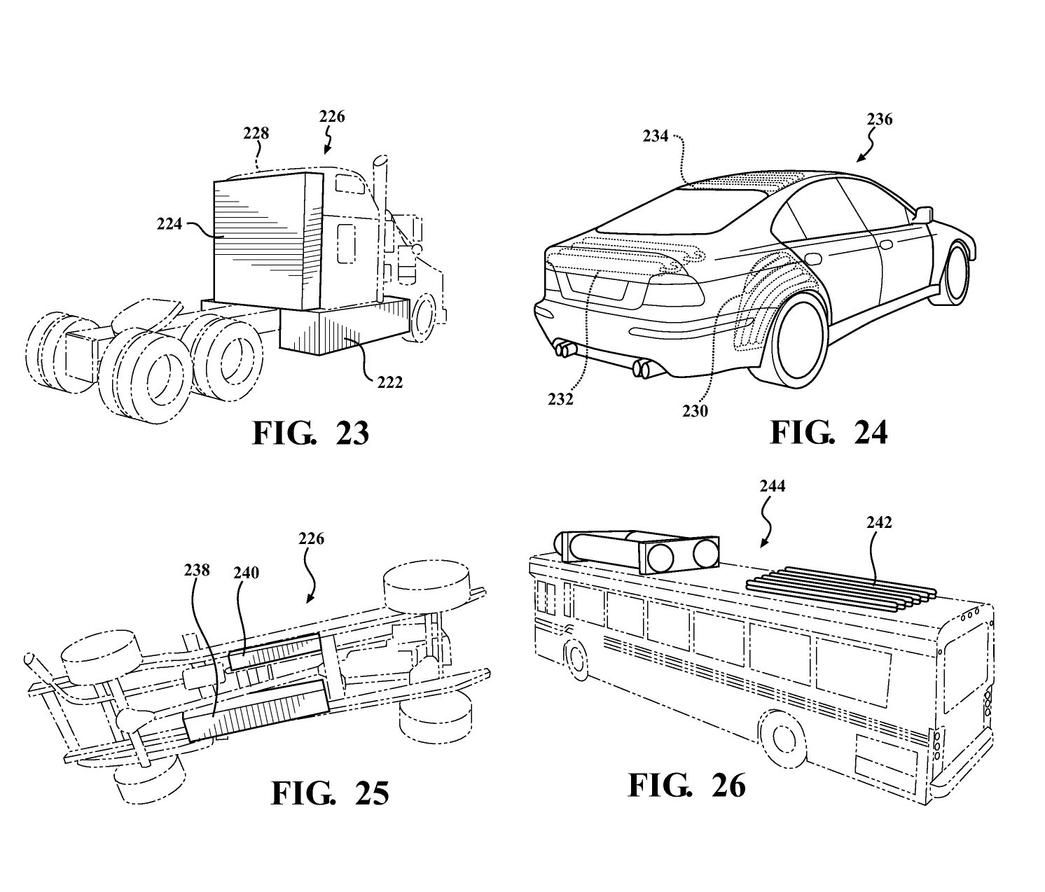

FIG. 23 is a perspective view of shaped containers 222, 224 containing continuous, flexible pressure vessels attached to the sides and behind the cab of a truck 226. One example shaped container 222 can be formed to replace one or more side-mounted fuel tanks on the truck 226. Another example shaped container 224 can be formed to fit behind a cab 228 of the truck 226.

FIG. 24 is a perspective view of shaped containers 230, 232, 234 containing continuous, flexible pressure vessels formed to fit within the trunk lid, roof, hood and/or fenders of a vehicle 236. For example, shaped container 232 is formed to fit adjacent to an interior surface of the trunk of the vehicle 236. As another example, the shaped container 234 is formed to fit adjacent to the roof of the vehicle 236. In still a further variant, the shaped container 230 is formed to fit within one or more fenders of the vehicle 236. In another variant (not shown), at least one shaped container can be formed to fit adjacent to an underside of the hood of the vehicle 236.

FIG. 25 is a perspective view of shaped containers 238, 240 containing continuous, flexible pressure vessels formed to fit within and around a chassis of the truck of FIG. 23. The shaped containers 238, 240 in this example can be formed to fit below, within, or around the chassis of the truck 226.

FIG. 26 is a perspective view of a continuous, flexible pressure vessel 242 formed to fit on a roof of a bus 244. In this example, the flexible pressure vessel 242 can be installed on the roof of a vehicle, such as the bus 244, either with or without the use of a shaped container. FIGS. 23-26 all describe various continuous pressure vessels that can be packaged for use in vehicular applications. Continuous pressure vessels, for example, scaled in size, can also be packaged for use in healthcare and diving applications, as further described below.

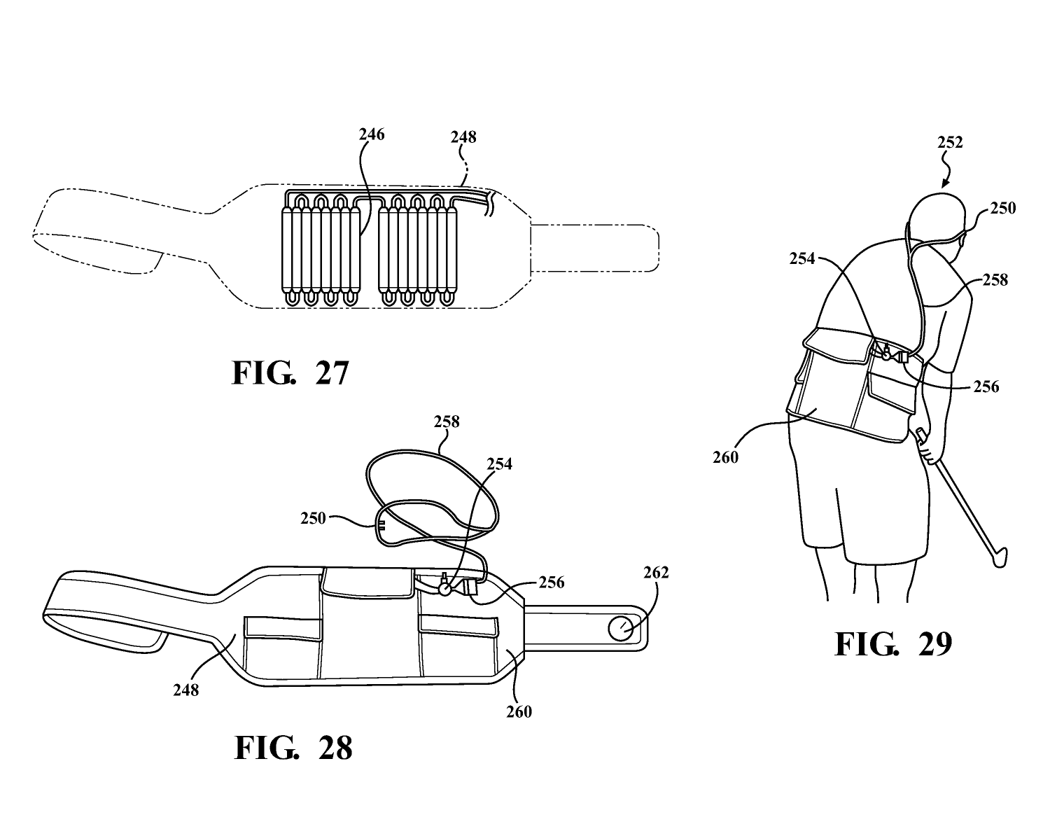

FIG. 27 is a side view of a continuous pressure vessel 246 within an outline representing an oxygen belt breathing pack 248. The continuous pressure vessel 246 can be folded within the oxygen belt breathing pack 248 as shown or can alternatively be coiled within the oxygen belt breathing pack 248 (not shown).

FIG. 28 is a side view of the oxygen belt breathing pack 248 of FIG. 27 including a nasal cannula 250 and a manifold 254. The manifold 254 can be connected to the pressure vessel 246 and can optionally include an overpressure rupture fitting (not shown). The manifold 254 can provide connections for a high pressure regulator 256, a pressure gauge to measure pressure, and an oxygen fill source for the pressure vessel 246. The high pressure regulator 256 can be a separate piece or an integral portion of the manifold 254 and can include a demand valve to supply oxygen directly to the nasal cannula 250 at a reduced pressure. A low pressure hose 258 can be connected to the high pressure regulator 256 and the nasal cannula 250 can be connected to the low pressure hose 258.

A flexible container for the continuous pressure vessel 246 in the form of a pouch or belt 260 is also provided. The belt 260 is formed of resilient material and is sized and shaped to accommodate the at least one pressure vessel 246 and allow attachment of the manifold 254. A remotely mounted pressure display device 262 can also be included on the belt 260. The display device 262 can receive wireless signals from a pressure transducer in fluid communication with the at least one pressure vessel 246 and display a pressure reading, for example, to an ambulatory care patient.

FIG. 29 is a rear view of the oxygen belt breathing pack 248 of FIG. 28 as worn by an ambulatory care patient 252. As shown in FIG. 29, the belt 260 can be worn about the waist of the ambulatory care patient 252, allowing the ambulatory care patient 252 the freedom to partake in physical activities, such as golfing, that would be difficult if using prior art breathing systems such as heavy metallic reservoirs mounted to a wheeled trolley or back pack. The pressure vessels previously described for use within vehicular and healthcare applications can also be used by divers.

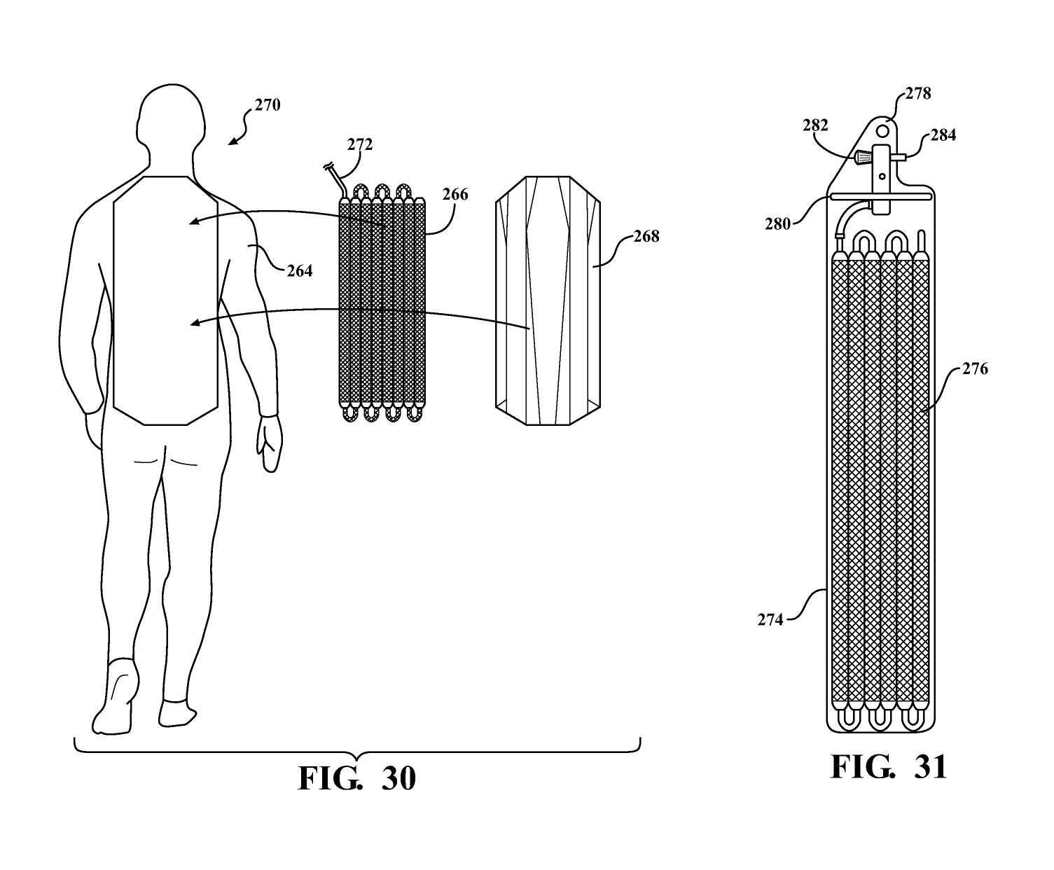

FIG. 30 is an exploded rear view of a dive suit 264 illustrating the assembly of a corrugated, continuous pressure vessel 266 and a hydrodynamic container 268. The dive suit 264 can be formed of flexible material and shaped to fit about the body of a diver 270. The hydrodynamic container 268 can be formed of resilient material and is sized and shaped to accommodate the pressure vessel 266, sections of flexible conduit 272, and, optionally, a manifold (not shown). The hydrodynamic container 268 is integrally attached to the dive suit 264 and is sized and shaped to present a minimized cross-sectional area for a diver 270 using the dive suit 264. The hydrodynamic container 268 can include openings sized and shaped to accommodate passage of at least one connecting hose and a connection to an air fill source (not shown). As illustrated in FIG. 30, the corrugated, continuous pressure vessel 266 is located in a dorsal portion of the dive suit 264. The arrows illustrate how the corrugated, continuous pressure vessel 266 is packaged within the hydrodynamic container 268 and onto the dive suit 264.

FIG. 31 is a side cut-away view of a portable container 274 including a continuous, flexible pressure vessel 276 similar to those described in FIGS. 1-8. In this example, the pressure vessel 276 is designed to hold CNG for use in remote or standalone power systems such as generators, all-terrain vehicles, emergency service applications, military applications, or bulk storage units for CNG fuel. The portable container 274 can, for example, be carried as a refill for the described power systems and vehicles.

The portable container 274 can include a lift bar 278 sufficient to receive, for example, a hook at the top of the portable container 274. The lift bar 278 can allow the portable container 274 to be hoisted up onto a vehicle or other vessel using a crane. The portable container 274 can also include a mounting plate 280 shaped to fit existing mounting brackets present, for example, on emergency response, military, and/or gas transportation vehicles. The mounting plate 280 can include a support for a manifold valve 282 and a regulator 284 allowing a fill line to be connected to the pressure vessel 276 through a manifold.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims. The scope of the claims is to be accorded the broadest interpretation so as to encompass all such modifications and equivalent structures as is permitted under the law.

What is claimed is:

1. A pressure vessel, comprising:
a continuous liner of corrugated material including a plurality of alternating main sections and intermediate sections, wherein the main sections have a first diameter and the intermediate sections have a second diameter smaller than the first diameter; and
a reinforcing layer applied to an exterior of the continuous liner.

2. The pressure vessel of claim 1, wherein the continuous liner is formed by one of an extrusion process, a hydroform process, and a metal spinning process prior to corrugation.

3. The pressure vessel of claim 1, wherein the corrugated material is at least one of polymeric, aluminum, copper, and stainless steel.

4. The pressure vessel of claim 1, wherein the main sections have at least one of an elongated cylindrical shape, an ovoid shape, and a spherical shape.

5. The pressure vessel of claim 1, wherein the first diameter is approximately three times the second diameter.

6. The pressure vessel of claim 1, wherein the reinforcing layer includes at least one of high-strength fibers, resin-impregnated tape, ballistic ribbon, and pre-formed fiber tubes.

7. The pressure vessel of claim 1, wherein the continuous liner is rotated and translated during the application of the reinforcing layer.

8. The pressure vessel of claim 1, wherein the continuous liner is exposed to at least one of an ultraviolet light source, a pressurized air source, and a heated air source during the application of the reinforcing layer.

9. The pressure vessel of claim 1, wherein the reinforcing layer is a first reinforcing layer, the pressure vessel further comprising:
a second reinforcing layer applied to an exterior of the first reinforcing layer.

10. The pressure vessel of claim 1, further comprising:
a container shaped to receive the continuous liner folded along one or more of the intermediate sections.

11. A method of forming a pressure vessel, comprising:
forming a continuous liner;
corrugating the continuous liner, wherein the corrugating includes forming a plurality of alternating main sections and intermediate sections and wherein the main sections have a first diameter and the intermediate sections have a second diameter smaller than the first diameter;
applying a reinforcing layer to an exterior of the continuous liner;
folding the continuous liner along one or more of the intermediate sections; and
packaging the folded continuous liner within at least one shaped container.

12. The method of claim 11, wherein the forming includes one of an extrusion process, a hydroform process, and a metal spinning process.

13. The method of claim 11, wherein the continuous liner includes at least one of a polymeric, an aluminum, a copper, and a stainless steel material.

14. The method of claim 11, wherein the reinforcing layer includes at least one of high-strength fibers, resin-impregnated tape, ballistic ribbon, and pre-formed fiber tubes.

15. The method of claim 11, wherein the method further comprises:
rotating and translating the continuous liner while applying the reinforcing layer.

16. The method of claim 11, wherein applying the reinforcing layer includes exposing the continuous liner to at least one of an ultraviolet light source, a pressurized air source, and a heated air source.

17. The method of claim 11, wherein the reinforcing layer is a first reinforcing layer, the method further comprising:
applying a second reinforcing layer to an exterior of the first reinforcing layer.

18. The method of claim 11, wherein the container is shaped to receive the continuous liner folded along one or more of the intermediate sections.

19. A modular pressure vessel, comprising:
a continuous liner including a plurality of alternating main sections and corrugated intermediate sections, wherein the main sections have a first diameter and the corrugated intermediate sections have a second diameter smaller than the first diameter;
a reinforcing layer applied to an exterior of the continuous liner; and
a plurality of containers each shaped to receive a portion of the reinforced continuous liner folded along one or more of the corrugated intermediate sections.

20. The modular pressure vessel of claim 19, wherein each of the plurality of containers is configured for exchangeability with another of the plurality of containers within the modular pressure vessel.
